(19) United States
(12) Patent Application Publication
(10) Pub. No.: US 2006/0170321 A1
(43) Pub. Date: Aug. 3, 2006

(54) Flat-type fluorescent lamp and liquid crystal display apparatus having the same

(76) Inventors: Yong-Woo Lee, Suwon-si (KR); Jae-Sang Lee, Suwon-si (KR)

Correspondence Address: CANTOR COLBURN, LLP, 55 GRIFFIN ROAD SOUTH, BLOOMFIELD, CT, 06002, US

(21) Appl. No.: 11/328,897

(22) Filed: Jan. 10, 2006

(30) Foreign Application Priority Data
Jan. 10, 2005 (KR) 2005-2234

(51) Int. Cl. H01J 11/00; H01J 65/00

(52) U.S. Cl. 313/234; 313/607

(57) ABSTRACT

A flat-type fluorescent lamp includes a lamp body having a plurality of discharge spaces emitting a light, first and second external electrodes formed on upper and lower faces of the lamp body, respectively, a conductive clip electrically connecting the first and second external electrodes, and an insulating member covering and insulating the conductive clip. The conductive clip includes a first contact portion contacting the first external electrode, a second contact portion contacting the second external electrode, and a body portion connecting the first and second contact portions. The insulating member includes a recess into which the body portion is inserted. Thus, an electrical defect such as arc discharge between the receiving container and the external conductors may be prevented.

This application claims priority to Korean Patent Application No. 2005-2234, filed on Jan. 10, 2005 and all the benefits accruing therefrom under 35 U.S.C. §119, and the contents of which in its entirety are herein incorporated by reference.

### BACKGROUND OF THE INVENTION

1. Field of the Invention

The present invention relates to a flat-type fluorescent lamp and a liquid crystal display (“LCD”) apparatus having the flat-type fluorescent lamp. More particularly, the present invention relates to a flat-type fluorescent lamp capable of stably connecting external electrodes formed on upper and lower faces of a lamp body, respectively, and an LCD apparatus having the flat-type fluorescent lamp.

2. Description of the Related Art

In general, a liquid crystal display (“LCD”) apparatus displays an image using optical and electrical properties of liquid crystal, such as an anisotropic refractive index and an anisotropic dielectric constant. The LCD apparatus has characteristics, such as a light weight structure, lower power consumption, lower driving voltage, etc., in comparison with a display apparatus such as a cathode ray tube, a plasma display panel and so on.

The LCD apparatus requires a light source since its display panel is not self-emissive. A tubular-shaped cold cathode fluorescent lamp is often used for the light source of the LCD apparatus. However, for a large-scaled LCD apparatus, a flat-type fluorescent lamp having uniform brightness and low manufacturing cost has been developed.

The flat-type fluorescent lamp includes a lamp body divided into a plurality of discharge spaces and an electrode applying a discharge voltage to the lamp body. The electrode is formed inside or outside the lamp body, and the electrode is formed on upper and lower faces of the lamp body considering manufacturing efficiency and discharge efficiency thereof. The flat-type fluorescent lamp makes a plasma discharge in the discharge spaces in response to the discharge voltage applied to the electrode from the flat-type fluorescent lamp. A fluorescent layer inside the lamp body is excited in response to ultraviolet light that is generated by the plasma discharge of the discharge spaces to emit the visual light.

When the electrodes are formed on the upper and lower faces of the lamp body, the flat-type fluorescent lamp requires a separate conductive clip so as to electrically connect the electrodes to each other. However, since the discharge voltage at a high voltage is applied to the conductive clip, an arc discharge occurs between the conductive clip and a receiving container receiving the lamp body. Further, the conductive clip is not normally coupled to the flat-type fluorescent lamp due to deformation thereof.

### BRIEF SUMMARY OF THE INVENTION

The present invention provides a flat-type fluorescent lamp capable of stably connecting external electrodes formed on upper and lower faces of a lamp body, respectively.

The present invention also provides a liquid crystal display (“LCD”) apparatus having the above-described flat-type fluorescent lamp.

In exemplary embodiments of the present invention, a flat-type fluorescent lamp includes a lamp body, an external electrode, a conductive clip, and an insulating member. The lamp body includes a plurality of discharge spaces emitting a light. The external electrode is formed on at least one face of an upper face and a lower face of the lamp body. The conductive clip is electrically connected to the external electrode. The insulating member covers the conductive clip and insulates the conductive clip.

The external electrode includes a first external electrode formed on the upper face of the lamp body and a second external electrode formed on the lower face of the lamp body. The conductive clip includes a first contact portion making contact with the first external electrode, a second contact portion making contact with the second external electrode, and a body portion connecting the first contact portion and the second contact portion. The insulating member covers the body portion.

The insulating member includes a recess into which the body portion is inserted. The insulating member may have a unitary structure. The insulating member may include a first insulating part disposed between the lamp body and the body portion, and a second insulating part coupled to the first insulating part to cover the body portion, and the first and second insulating parts may be separable. The first and second insulating parts may be coupled via a fixing recess and a fixing protrusion. The first insulating part may include an indentation sized to receive the body portion.

The insulating member may be separable from the conductive clip, and the insulating member protects the conductive clip from deformation and prevents an arc discharge from occurring between the conductive clip and a conductive member, such as a receiving container, exterior of the flat-type fluorescent lamp.

In other exemplary embodiments of the present invention, an LCD apparatus includes a flat-type fluorescent lamp, an inverter, and an LCD panel. The flat-type fluorescent lamp includes a lamp body emitting a light, an external electrode formed on at least one face of an upper face and a lower face of the lamp body, a conductive clip electrically connected to the external electrode, and an insulating member covering the conductive clip and insulating the conductive clip. The inverter applies a discharge voltage to the conductive clip for the flat-type fluorescent lamp. The LCD panel displays an image using a light applied from the flat-type fluorescent lamp.

According to the present invention, the insulating member may prevent deformation of the conductive member, so that the conductive clip may have enhanced assembling efficiency, as well as preventing an electrical defect such as an arc discharge between the conductive clip and a receiving container.

### BRIEF DESCRIPTION OF THE DRAWINGS

The above and other advantages of the present invention will become readily apparent by reference to the following detailed description when considered in conjunction with the accompanying drawings wherein:

FIG. 1 is a perspective view showing an exemplary embodiment of a flat-type fluorescent lamp according to the present invention;

FIG. 2 is an enlarged view of portion ‘A’ in FIG. 1;

FIG. 3 is a cross-sectional view taken along line I-I′ of FIG. 2;

FIG. 4 is an exploded perspective view showing an exemplary conductive clip and an exemplary insulating member in FIG. 2;

FIG. 5 is an exploded perspective view showing another exemplary embodiment of an insulating member according to the present invention;

FIG. 6 is a cross-sectional view taken along line II-II′ showing an exemplary lamp body in FIG. 1; and

FIG. 7 is an exploded perspective view showing an exemplary embodiment of an LCD apparatus according to the present invention.

### DETAILED DESCRIPTION OF THE INVENTION

Hereinafter, the present invention will be explained in detail with reference to the accompanying drawings. In the drawings, the thickness of certain layers, films, regions, and elements may be exaggerating for clarity. Like numerals refer to like elements throughout. It will be understood that when an element such as a layer, film, region, or substrate is referred to as being “on” another element, it can be directly on the other element or intervening elements may also be present.

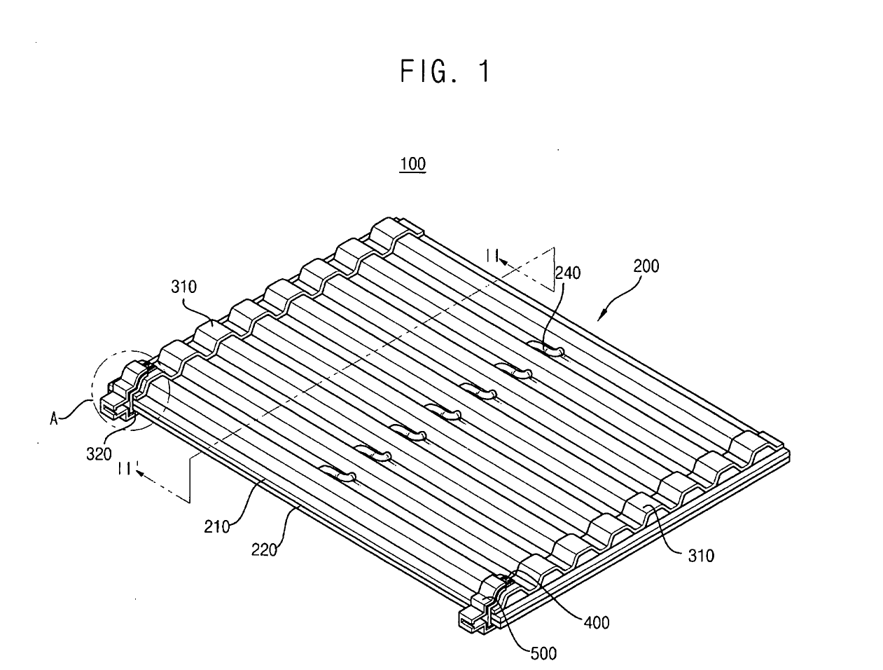

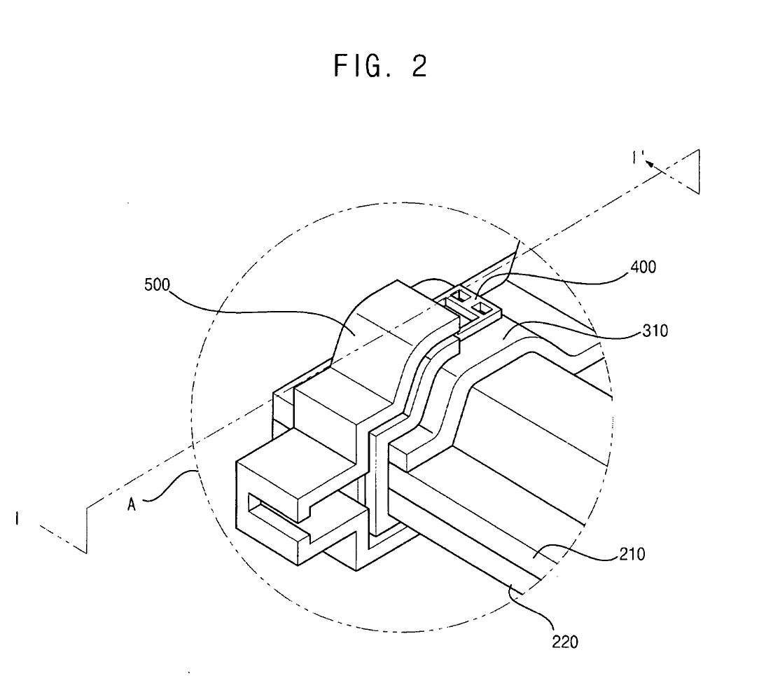

FIG. 1 is a perspective view showing an exemplary embodiment of a flat-type fluorescent lamp according to the present invention. FIG. 2 is an enlarged view of portion ‘A’ in FIG. 1.

Referring to FIGS. 1 and 2, a flat-type fluorescent lamp 100 includes a lamp body 200, a first external electrode 310, a second external electrode 320, a conductive clip 400, and an insulating member 500.

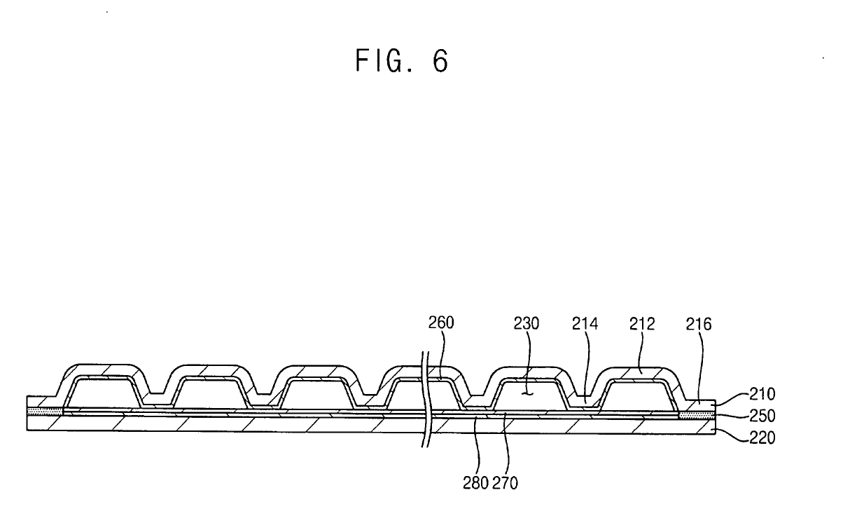

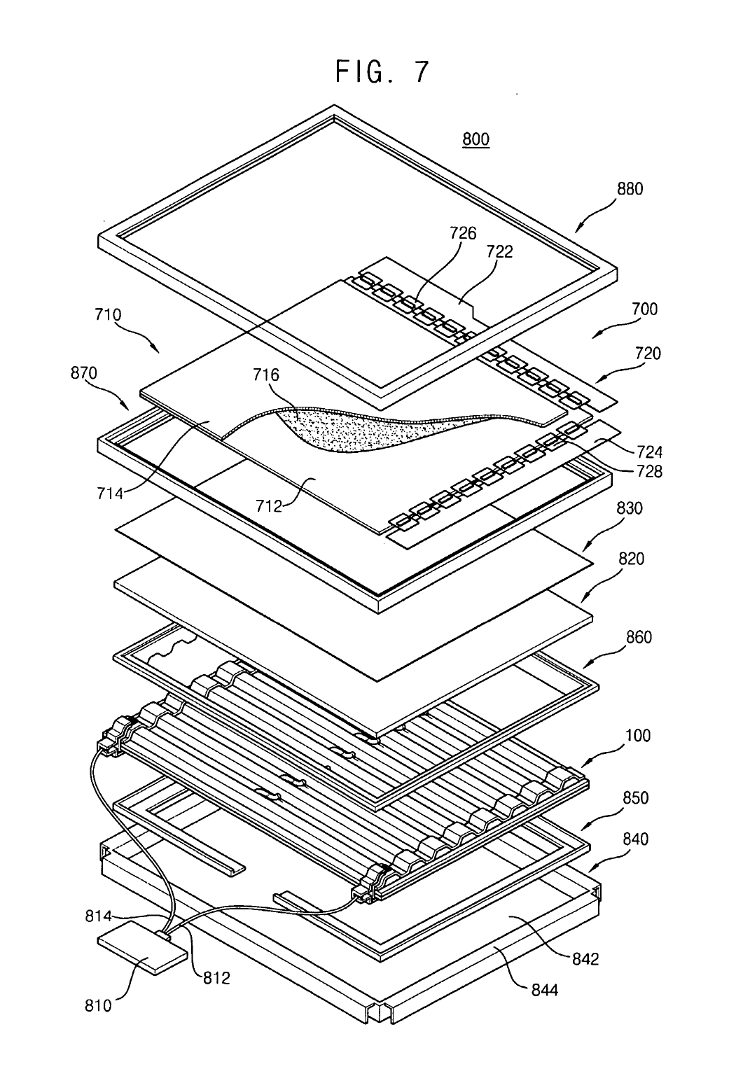

The lamp body 200 is divided into a plurality of discharge spaces, as will be further described below with respect to FIG. 6, so as to emit a light. In order to emit the light as a planar light, the lamp body 200 in plan view has a substantially rectangular shape. The lamp body 200 may have first and second sides substantially parallel to each other and extending in a first direction, substantially parallel to a longitudinal direction of the discharge spaces, and third and fourth sides substantially parallel to each other and extending in a second direction, substantially perpendicular to the longitudinal direction of the discharge spaces. The lamp body 200 makes a plasma discharge in the discharge spaces in response to a discharge voltage applied from an inverter, as will be further described below with respect to FIG. 7, to the first and second external electrodes 310 and 320. The lamp body 200 converts ultraviolet light generated due to the plasma discharge into visible light and emits the visible light through an upper surface of the lamp body 200. The lamp body 200 has a wider light-emitting area divided into the discharge spaces, so that the lamp body 200 may improve light emitting efficiency and emit uniform light. The lamp body 200 includes a first substrate 210 and a second substrate 220 coupled to the first substrate 210 to form the discharge spaces. The light is emitted through the first substrate 210.

The first external electrode 310 is formed on an outer face of the first substrate 210. The first external electrode 310 is formed on both ends of the first substrate 210, adjacent the third and fourth sides of the lamp body 200, such that the first external electrode 310 is intersected with each of the discharge spaces. The first substrate 210 includes the outer face and an inner face, where the inner face faces the discharge spaces and the first external electrode 310 is positioned on the outer face of the first substrate 210. The first external electrode 310 includes an outer surface and an inner surface, where the inner surface of the first external electrode 310 contacts the outer face of the first substrate 210. The second external electrode 320 is formed on an outer face of the second substrate 220. The second external electrode 320 is formed on both ends of the second substrate 220, adjacent the third and fourth sides of the lamp body 200 and corresponding to the first external electrode 310, so that the second external electrode 320 is also intersected with each of the discharge spaces. The second substrate 220 includes an outer face and an inner face, where the inner face faces the discharge spaces and the second external electrode 320 is positioned on the outer face of the second substrate 220. The inner face of the second substrate 220 faces the inner face of the first substrate 210. The second external electrode 320 includes an outer surface and an inner surface, where the inner surface of the second external electrode 320 contacts the outer face of the second substrate 220.

The first and second external electrodes 310 and 320 include a conductive material so as to apply the discharge voltage from the inverter to the lamp body 200. The first and second external electrodes 310 and 320 may be coated by means of a silver paste having silver (Ag) and silicon oxide (SiO₂). Alternatively, the first and second external electrodes 310 and 320 may be formed using a spray coating method of a metal powder having a metal or a metal composition. Although not shown in FIGS. 1 and 2, an insulating layer may be further formed on outer faces of the first and second external electrodes 310 and 320 so as to protect the first and second external electrodes 310 and 320. The insulating layer may be partially opened through an area corresponding to the conductive clip 400 to expose the first and second external electrodes 310 and 320 for ensuring electrical contact between the conductive clip 400 and the first and second external electrodes 310 and 320.

The first external electrode 310 and the second external electrode 320 may be removed from the lamp body 200.

The conductive clip 400 is electrically connected to the first and second external electrodes 310 and 320 so as to apply the discharge voltage from the inverter to the lamp body 200. The conductive clip 400 electrically connects the first and second external electrodes 310 and 320, formed on the upper face and the lower face of the lamp body 200, to each other. More particularly, the conductive clip 400 contacts the outer surfaces of the first and second external electrodes 310 and 320. The conductive clip 400 is coupled to the lamp body 200 corresponding to the first and second external electrodes 310 and 320. The conductive clip 400 may be soldered to the first and second external electrodes 310 and 320. Alternatively, the conductive clip 400 may be electrically connected to the first and second external electrodes 310 and 320 using a conductive adhesive, such as, for example, an anisotropic conductive film (“ACF”) or the silver paste. The conductive clip 400 substantially simultaneously applies the discharge voltage from the inverter to the first and second external electrodes 310 and 320. In one embodiment, the conductive clip 400 may have a width that is equal to or less than a width of one of the first and second external electrodes 310 and 320. Thus, the first and second external electrodes 310 and 320 may be entirely or partially covered with the conductive clip 400.

The insulating member 500 wraps the conductive clip 400 to insulate the conductive clip 400 from elements of the flat-type fluorescent lamp 100, excluding the first and second external electrodes 310 and 320. That is, the insulating member 500 covers the conductive clip 400 such that a portion of the conductive clip 400, excluding areas where the conductive clip 400 makes contact with the first and second external electrodes 310 and 320, is not exposed. The insulating member 500 includes an insulating material such as, but not limited to, polycarbonate.

The insulating member 500 prevents the conductive clip 400 from being exposed, so that an electrical defect such as the arc discharge between the conductive clip 400 and a receiving container, receiving the flat type fluorescent lamp 100, may be prevented. Further, the insulating member 500 may prevent deformation of the conductive clip 400.

As shown in FIGS. 1 and 2, the insulating member 500 is combined with the conductive clip 400 in a direction that is substantially perpendicular to a longitudinal direction of each discharge space. In other words, the insulating member 500 and the conductive clip 400 are placed on the first and second external electrodes 310 and 320 in a direction substantially parallel to the third and fourth sides of the lamp body 200. Alternatively, the insulating member 500 may be combined with the conductive clip 400 in a direction that is substantially parallel with the longitudinal direction of each discharge space, such as substantially parallel to the first and second sides of the lamp body 200.

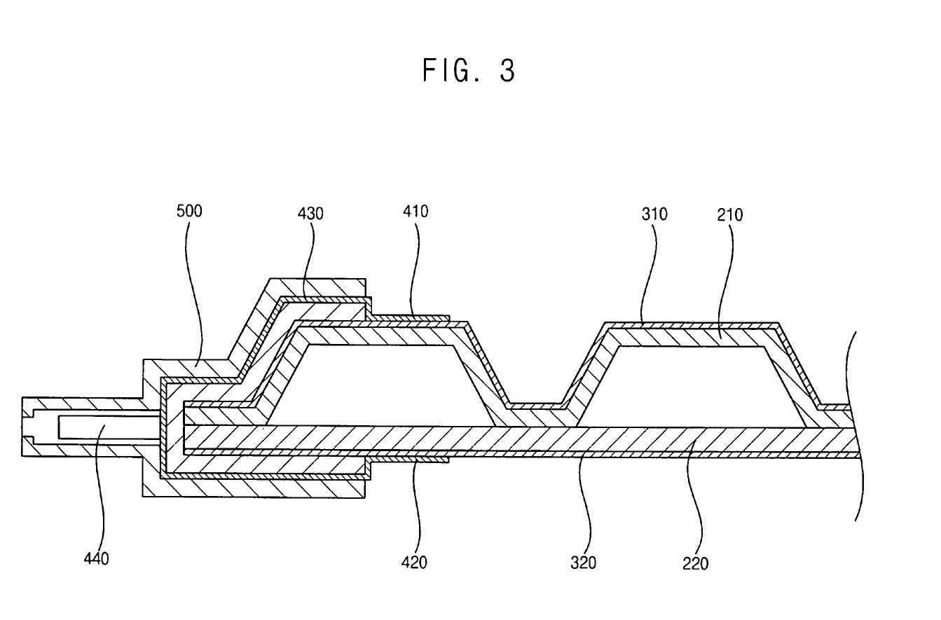

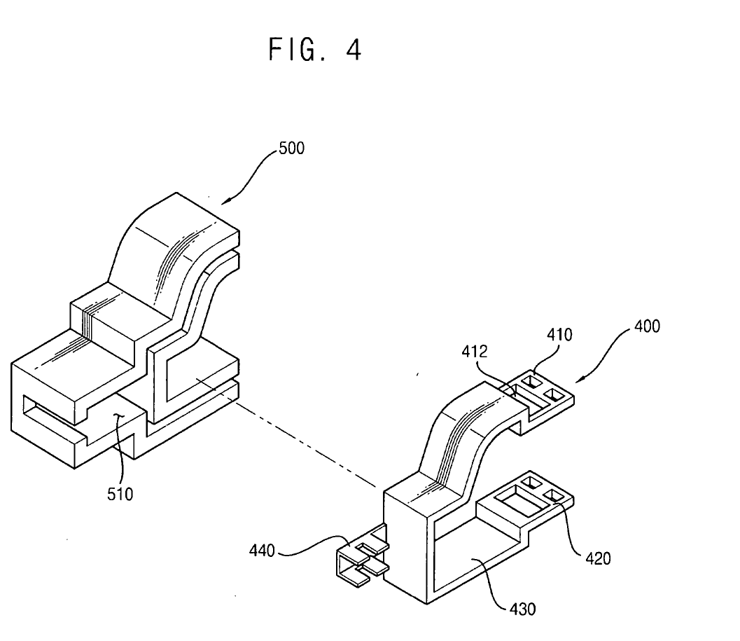

FIG. 3 is a cross-sectional view taken along line I-I′ of FIG. 2. FIG. 4 is an exploded perspective view showing an exemplary conductive clip and an exemplary insulating member in FIG. 2.

Referring to FIGS. 3 and 4, the conductive clip 400 and the insulating member 500 are coupled to the lamp body 200 corresponding to the first external electrode 310 and the second external electrode 320. The conductive clip 400 electrically connects the first external electrode 310 and the second external electrode 320, and the conductive clip 400 is insulated by means of the insulating member 500 except for the areas where the conductive clip 400 makes contact with the first and second external electrodes 310 and 320.

The conductive clip 400 includes a conductive metal to electrically connect the first external electrode 310 to the second external electrode 320. The conductive clip 400 includes a first contact portion 410 making contact with the first external electrode 310, a second contact portion 420 making contact with the second external electrode 320, and a body portion 430 connecting the first contact portion 410 to the second contact portion 420. The conductive clip 400 may be a solid, unitary structure. As illustrated, the first contact portion 410 is substantially parallel to the second contact portion 420, however the first contact portion 410 may alternatively be positioned at various locations along the irregular surface of the first substrate 210.

In order to stably couple the conductive clip 400 to the lamp body 200, the first and second contact portions 410 and 420 are soldered to the outer surfaces of the first and second external electrodes 310 and 320, respectively, after the conductive clip 400 is coupled to the lamp body 200. For high reliability of the soldering, the first and second contact portions 410 and 420 include at least one hole 412 formed there through. When the hole or holes 412 are formed through the first and second contact portions 410 and 420, heat from a solder is applied to only soldering areas of the first and second contact portions 410 and 420. That is, the first and second contact portions 410 and 420 having the hole or holes 412 may prevent heat transmission to an area adjacent to the soldering areas, so that only the temperature of the soldering areas increases to obtain the high reliability of the soldering. The hole or holes 412 may have various shapes. In the present embodiment, the hole 412 may include three separate holes of a substantially rectangular shape for the high reliability of the soldering. Alternatively, the conductive clip 400 may include tin (Sn) plated on a surface thereof, thereby increasing efficiency of the soldering and preventing oxidation of the conductive clip 400.

The body portion 430 connects the first contact portion 410 and the second contact portion 420 while covering a portion of the side portion of the lamp body 200, such as a portion of the first side of the lamp body 200. The body portion 430 has a shape corresponding to a shape of a conductive clip-covered section of the lamp body 200. In the illustrated embodiment, the body portion 430 includes an angled or curved portion overlying a section of a discharge space portion of the first substrate 210, a first flat portion overlying a sealing portion of the first substrate 210, a second flat portion substantially perpendicular to the first flat portion and extending adjacent a side, such as the first side, of the lamp body 200, and a third flat portion substantially perpendicular to the second flat portion for underlying the second substrate 220. Of course, alternate shapes of the body portion 430 that correspond to alternate shapes of the lamp body 200 would also be within the scope of these embodiments. The body portion 430 further includes a fixing portion 440 so as to receive the discharge voltage applied from the inverter. In the illustrated embodiment, the fixing portion 440 extends from the second flat portion of the body portion 430. The fixing portion 440 is coupled to a power line from the inverter to which the discharge voltage is applied. The fixing portion 440 is partially opened to have a substantially U-shaped cross-section to receive the power line. When the fixing portion 440 is pressurized, such as pinched, squeezed, or otherwise forced to close, after the power line is inserted into the partially opened portion, the power line may be fixed to the fixing portion 440 of the body portion 430.

The insulating member 500 covers the body portion 430 of the conductive clip 400 such that the body portion 430 is not exposed. The insulating member 500 includes the insulating material so as to allow the conductive clip 400 to be insulated from conductors such as the receiving container that receives the flat type fluorescent lamp 100. The insulating member 500 has a shape corresponding to the body portion 430 of the conductive clip 400 to receive the body portion 430. Further, the insulating member 500 has the shape corresponding to the lamp body 200 such that the insulating member 500 may be cohered to the lamp body 200, thereby preventing movement of the insulating member 500. The insulating member 500 may include an exterior surface and an interior surface, where the interior surface makes contact with portions of the first and second external electrodes 310, 320 and portions of the sides of the first and second substrates 210, 220.

In the present embodiment, the insulating member 500 includes a recess 510, between the exterior and interior surfaces of the insulating member 500, into which the body portion 430 is inserted. The recess 510 has a depth sufficient enough to completely receive the body portion 430 of the conductive clip 400. Thus, the insulating member 500 covers both inner and outer faces of the body portion 430 when the body portion 430 is inserted in the recess 510 of the insulating member 500. In order to prevent movement and deformation of the conductive clip 400, the recess 510 has substantially the same shape and size as those of the body portion 430 of the conductive clip 400.

The insulating member 500 is coupled to the lamp body 200 after the conductive clip 400 is inserted into the recess 510 of the insulating member 500. However, the conductive clip 400 may be inserted into the recess 510 of the insulating member 500 after the insulating member 500 is coupled to the lamp body 200.

The insulating member 500 protects the conductive clip 400 from deformation, and therefore the conductive clip 400 has a stable connection with the first and second external electrodes 310, 320 and the lamp body 200. Also, the insulating member 500 prevents an electrical defect such as the arc discharge between a receiving container receiving the lamp body 200 and the conductive clip 400.

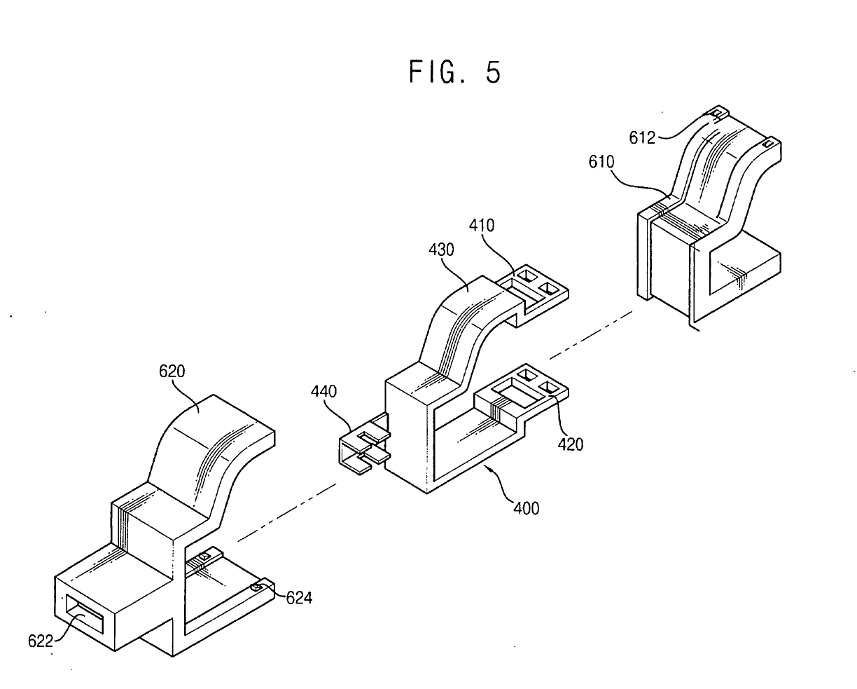

FIG. 5 is an exploded perspective view showing another exemplary embodiment of an insulating member according to the present invention. In FIG. 5, the same reference numerals denote the same elements in FIG. 4, and thus any further detailed descriptions of the same elements will be omitted.

Referring to FIG. 5, an insulating member includes a first insulating part 610 that covers the inner face of the body portion 430 of the conductive clip 400 and a second insulating part 620 that covers the outer face of the body portion 430 of the conductive clip 400. The first insulating part 610 is coupled to the second insulating part 620.

The first insulating part 610 is disposed between the lamp body 200 and the body portion 430 of the conductive clip 400. The first insulating part 610 isolates the lamp body 200 apart from the body portion 430 of the conductive clip 400, thereby preventing crystallization of a frit formed in the lamp body 200, where the frit may be formed between the first and second substrates 210, 220 for adhering the first and second substrates 210, 220 together. The first insulating portion 610 includes a recess, groove, or indentation on an outer face of the first insulating portion 610 corresponding substantially in shape and size to the inner face of the body portion 430 such that the conductive clip 400 is stably coupled to the first insulating portion 610. The first insulating portion 610 has a shape on an inner face thereof corresponding to a portion of the side portion of the lamp body 200, so that the first insulating portion 610 may be cohered to the lamp body 200. The first insulating portion 610 includes a fixing recess 612 formed on an upper face and/or a lower face of the outer face of the first insulating portion 610 so as to stably couple the first insulating portion 610 to the second insulating portion 620.

The second insulating part 620 is coupled to the first insulating part 610 to cover the outer face of the body portion 430 of the conductive clip 400 after the conductive clip 400 is coupled to the first insulating part 610. The second insulating part 620 includes an opening 622 through which the power line connected to the fixing portion 440 of the conductive clip 400 is withdrawn. The second insulating part 620 includes a fixing protrusion 624 corresponding to the fixing recess 612, so that the first and second insulating parts 610 and 620 may be fixed to each other. Alternatively, the fixing protrusion 624 and the fixing recess 612 may be formed at the first insulating part 610 and the second insulating part 620, respectively. Also, other elements, structures, and devices for combining the first and second insulating parts 610, 620 together are within the scope of these embodiments. The conductive clip 400 may be stably fixed to the lamp body 200 and insulated from external conductors due to the first insulating part 610 coupled to the second insulating part 620.

The insulating member, including the first and second insulating parts 610, 620, is coupled to the lamp body 200 after the first insulating part 610, the conductive clip 400, and the second insulating part 620 are completely coupled to each other. Alternatively, the conductive clip 400 and the second insulating part 620 may be sequentially coupled to the first insulating part 610 after the first insulating part 610 is coupled to the lamp body 200.

The insulating member of FIG. 5 protects the conductive clip 400 from deformation, and therefore the conductive clip 400 has a stable connection with the first and second external electrodes 310, 320 and the lamp body 200. Also, the insulating member prevents an electrical defect such as the arc discharge between a receiving container receiving the lamp body 200 and the conductive clip 400.

FIG. 6 is a cross-sectional view taken along line II-II′ showing an exemplary lamp body in FIG. 1.

Referring to FIGS. 1 and 6, the lamp body 200 includes the first substrate 210 on which the first external electrode 310 is formed and the second substrate 220 on which the second external electrode 320 is formed. The first and second substrates 210 and 220 are coupled to each other so as to form a plurality of discharge spaces 230.

The first substrate 210 includes a transparent material through which the visible light generated in the discharge spaces 230 is transmitted. In the present embodiment, the first substrate 210 may include glass. The first substrate 210 may further include a material blocking the ultraviolet light such that the ultraviolet light generated in the discharge spaces 230 is not leaked out.

The first substrate 210 includes a plurality of discharge space portions 212, a plurality of space-dividing portions 214, and a sealing portion 216, all of which may be integrally formed within the first substrate 210. In an assembled condition of the lamp body 200, the discharge space portions 212 are spaced apart from the second substrate 220 to provide the discharge spaces 230. The space-dividing portions 214 are disposed between adjacent discharge space portions 212 and make contact with the second substrate 220 to divide the space between the first and second substrates 210, 220 into the discharge spaces 230. The sealing portion 216 is formed along an end of the first substrate 210 and coupled to the second substrate 220. The sealing portion 216 may be formed adjacent the first and second sides of the lamp body 200, as well as adjacent the third and fourth sides of the lamp body 200. In other words, the sealing portion 216 may follow a periphery of the first substrate 210.

The first substrate 210 is formed in a molding process. That is, when a base substrate having a plate-like shape is heated at a predetermined temperature and molded through a mold, the first substrate 210 having the discharge space portions 212, the space-dividing portions 214, and the sealing portion 216 may be formed. The first substrate 210 may also be formed in such a manner that heats the base substrate and injects an air into the heated base substrate.

The first substrate 210 has a cross-sectional profile having a plurality of half-arches arranged one after another as shown in FIG. 6. However, the first substrate 210 may be allowed to have various other cross-sectional profiles of the discharge space portion 212, for example, a semicircle, a square, and so on.

The first substrate 210 has a connection path 240, shown in FIG. 1, to connect adjacent discharge spaces 230 to each other. Each of the discharge spaces 230 is connected to adjacent discharge spaces 230 thereto by means of at least one connection path 240. A discharge gas injected into the discharge spaces 230 may be flowed to another discharge space 230 through the connection path 240 such that the discharge gas may be uniformly distributed into all discharge spaces 230.

The connection path 240 is substantially and simultaneously formed when the first substrate 210 is formed through the molding process. The connection path 240 may have various shapes. In the present embodiment, an example of the connection path may have an “S” shape. When the connection path 240 has the “S” shape, channeling phenomena due to interference between the discharge spaces 230 may be prevented since a flowing path through which the discharge gas flows is lengthened.

The second substrate 220 has a plate-like shape and a predetermined thickness, and may be substantially planar. In the present embodiment, the second substrate 220 may comprise glass, although other materials having appropriate properties may also be used. The second substrate 220 may further include a material blocking the ultraviolet light such that the ultraviolet light generated in the inner space between the first and second substrates 210, 220 is not leaked out.

The first substrate 210 is coupled to the second substrate 220 by means of an adhesive 250 such as a frit having a melting point lower than that of a glass. That is, the adhesive 250 is disposed between the first and second substrates 210 and 220 corresponding to the sealing portion 216 and a periphery of the second substrate 220, and then the adhesive 250 is heated, to thereby combine the first substrate 210 with the second substrate 220. In the present embodiment, the combination between the first and second substrates 210 and 220 is performed under a temperature from about 400 degrees to about 600 degrees Celsius.

The space-dividing portions 214 of the first substrate 210 are cohered to the second substrate 220 due to a pressure difference between an inner space and an outer space of the lamp body 200.

Particularly, when the first and second substrates 210 and 220 are coupled to each other and the air in the discharge spaces 230 is vented, the discharge spaces 230 of the lamp body 200 maintain inner spaces thereof in a vacuum state. Various discharge gases are injected into the discharge spaces 230 for the plasma discharge. Examples of the discharge gas may include mercury (Hg), neon (Ne), argon (Ar), and so on. In the present embodiment, a gas pressure of the discharge spaces 230 is maintained in a range of about 50 Torr to about 70 Torr lower than an atmospheric pressure of about 760 Torr. Due to a pressure difference between the gas pressure of the discharge spaces 230 and the atmospheric pressure, force is applied to the lamp body 200 toward the discharge spaces 230, so that the space-dividing portions 214 may be cohered to the second substrate 220. Thus, the discharge spaces 230 are separated from each other and do not communicate with each other except through the connection paths 240.

The lamp body 200 further includes a first fluorescent layer 260 and a second fluorescent layer 270. The first and second fluorescent layers 260 and 270 are formed on the first and second substrates 210 and 220 and between the first and second substrates 210 and 220 such that the first and second fluorescent layers 260 and 270 face each other. The first and second fluorescent layers 260 and 270 are excited by the ultraviolet lights caused by the plasma discharge in the discharge spaces 230 to emit the visible light.

The lamp body 200 further includes a reflecting layer 280 formed between the second substrate 220 and the second fluorescent layer 270. The reflecting layer 280 reflects the visible light emitted from the first and second fluorescent layers 260 and 270, thereby preventing the leakage of the visible light through the second substrate 220. Thus, the visible light may only exit the lamp body 200 through the first substrate 210. In order to enhance reflectance and reduce variation of color coordinates, the reflecting layer 280 includes a metal oxide such as aluminum oxide (Al₂O₃), barium sulfate (BaSO₄), or the like.

The first fluorescent layer 260, the second fluorescent layer 270, and the reflecting layer 280 may be sprayed onto the first and second substrates 210 and 220 before coupling the first substrate 210 to the second substrate 220. The first fluorescent layer 260, the second fluorescent layer 270, and the reflecting layer 280 are formed over the interior surfaces of the first and second substrates 210 and 220 except an area on which the sealing portion 216 is formed. Alternatively, the first fluorescent layer 260, the second fluorescent layer 270, and the reflecting layer 280 may not be formed on areas corresponding to the space-dividing portions 214.

Although not shown in FIG. 6, the lamp body 200 may further include a passivation layer formed between the first substrate 210 and the first fluorescent layer 260 and/or the second substrate 220 and the reflecting layer 280. The passivation layer blocks a chemical reaction between the first and second substrates 210 and 220 and the discharge gas such as the mercury (Hg), thereby preventing a loss of the mercury and blackening of the lamp body 200.

FIG. 7 is an exploded perspective view showing an exemplary embodiment of an LCD apparatus according to the present invention.

Referring to FIG. 7, an LCD apparatus 800 includes a flat-type fluorescent lamp 100 that emits the light, an inverter 810 that outputs the discharge voltage for the flat-type fluorescent lamp 100, and a display unit 700 that displays an image.

In the present embodiment, the flat-type fluorescent lamp 100 has the same structure and function as any of the embodiments of the flat-type fluorescent lamp in FIGS. 1 to 6, and any further detailed description of the flat-type fluorescent lamp 100 will be omitted.

The inverter 810 generates the discharge voltage for the flat-type fluorescent lamp 100. The inverter 810 boosts an alternating current voltage at a low voltage level to output an alternating current voltage at a high voltage level as the discharge voltage. The inverter 810 is electrically connected to the flat-type fluorescent lamp 100 by means of a first power line 812 and a second power line 814. Ends of the first and second power lines 812 and 814 are electrically connected to the fixing portion 440 of the conductive clip 400, as shown in FIGS. 3 to 5. Thus, the discharge voltage generated from the inverter 810 is applied to the first and second external electrodes 310 and 320 of the flat-type fluorescent lamp 100 through the conductive clip 400, and the first and second power lines 812 and 814.

The display unit 700 includes an LCD panel 710 that displays an image using a light from the flat-type fluorescent lamp 100 and a driving circuit 720 that drives the LCD panel 710.

The LCD panel 710 includes a first substrate 712, a second substrate 714 facing the first substrate 712, and a liquid crystal layer 716 disposed between the first and second substrates 712 and 714.

The first substrate 712 is a TFT substrate on which TFTs are formed in a matrix configuration. The first substrate 712 includes a glass, or other suitable transparent insulating layer, as a base. Each of the TFTs has a source connected to a data line, a gate connected to a gate line and a drain connected to a pixel electrode formed from a transparent and conductive material.

The second substrate 714 is a color filter substrate on which red, green, and blue (“RGB”) pixels are formed by a thin film process. The second substrate 714 also includes glass, or other suitable transparent insulating layer, as a base. The second substrate 714 includes a common electrode formed thereon. The common electrode includes a transparent conductive material.

When power is applied to the gate of the TFT and the TFT is turned on, electric field is generated between the pixel electrode and the common electrode. The electric field varies an aligning angle of the liquid crystal molecules in the liquid crystal layer 716 interposed between the first substrate 712 and the second substrate 714. Thus, the light transmittance of the liquid crystal layer 716 is varied in accordance with the variation of the aligning angle of the liquid crystal, so a desired image may be obtained.

The driving circuit 720 includes a data printed circuit board (“PCB”) 722 that applies a data driving signal to the LCD panel 710, a gate PCB 724 that applies a gate driving signal to the LCD panel 710, a data flexible printed circuit film 726 that electrically connects the data PCB 722 to the LCD panel 710 and a gate flexible printed circuit (“FPC”) film 728 that electrically connects the gate PCB 724 to the LCD panel 710. The data and gate FPC films 726 and 728 include a tape carrier package (“TCP”) or a chip-on-film (“COF”).

The data and gate PCBs 722 and 724 may be disposed on a side face or a rear face of the receiving container 840 by bending the data and gate FPC films 726 and 728, respectively. If separated signal lines are formed on the LCD panel 710 and the gate FPC film 728, then the gate PCB 724 may be removed.

The LCD apparatus 800 further includes a diffusion plate 820 and an optical sheet 830.

The diffusion plate 820 is disposed over the flat-type fluorescent lamp 100, between the flat-type fluorescent lamp 100 and the LCD panel 710, and spaced apart from the flat-type fluorescent lamp 100. The diffusion plate 820 has a plate-like shape. The diffusion plate 820 diffuses the light exiting from the flat-type fluorescent lamp 100 to improve the brightness uniformity of the light. The diffusion plate 820 includes a transparent material such as polymethyl methacrylate (“PMMA”). Also, the diffusion plate 820 may further include a light diffusing agent for the light.

The optical sheet 830 is disposed on the diffusion plate 820, and positioned between the diffusion plate 820 and the LCD panel 710. The optical sheet 830 may include various sheets such as a prism sheet and/or a diffusion sheet. The prism sheet condenses the diffused light by the diffusion plate 820 so as to enhance brightness at a front view, and the diffusion sheet diffuses again the diffused light by the diffusion plate 820. Further, the LCD apparatus 800 may include separate optical sheets in accordance with required brightness characteristics. In other embodiments, additional sheets not described herein may be incorporated within the optical sheet or sheets 830, and in still other embodiments, the optical sheet 830 may be excluded from the LCD apparatus. 800.

The LCD apparatus 800 further includes the receiving container 840 into which the flat-type fluorescent lamp 100 is received. The receiving container 840 includes a bottom portion 842 and a side portion 844 extended from the bottom portion 842 to provide a receiving space for the flat-type fluorescent lamp 100. The bottom portion 842 may be generally rectangular shaped to accept the fluorescent lamp 100 thereon. The side portion 844 is bent over two times, in an upside-down U-shape, in order to provide coupling space and coupling strength for other elements (not shown) of the LCD apparatus 800. The receiving container 840 includes a metal material having a superior strength to avoid deformation thereof.

The LCD apparatus 800 may further include a buffer member 850 disposed between the receiving container 840 and the flat-type fluorescent lamp 100 to support the flat-type fluorescent lamp 100. The buffer member 850 is disposed on the end of the flat-type fluorescent lamp 100. The buffer member 850 isolates the flat-type fluorescent lamp 100 apart from the receiving container 840 by a predetermined distance such that the flat-type fluorescent lamp 100 is not electrically connected to the receiving container 840. In order to electrically insulate the flat-type fluorescent lamp 100 from the receiving container 840, the buffer member 850 includes an insulating material. Also, the buffer member 850 has an elastic material such as silicon so as to absorb an impact externally applied to the flat-type fluorescent lamp 100 to protect the flat-type fluorescent lamp 100 from breakage. In the present embodiment, the buffer member 850 includes two pieces having a substantially U shape. However, the buffer member 850 may include four pieces corresponding to sides or corners of the flat-type fluorescent lamp 100, respectively. The four pieces of the buffer member 850 may be integrally formed into one piece.

The LCD apparatus 800 may further include a first mold 860 disposed between the flat-type fluorescent lamp 100 and the diffusion plate 820. The first mold 860 fixes an end of the flat-type fluorescent lamp 100 and supports an end of the diffusion plate 820. As shown in FIG. 7, the first mold 860 may be a frame that is integrally formed into one piece. However, the first mold 860 may include two pieces having a substantially U shape or four pieces corresponding to four sides of the flat-type fluorescent lamp 100, respectively.

Further, the LCD apparatus 800 may further include a second mold 870 disposed between the optical sheet 830 and the LCD panel 710. The second mold 870 fixes ends of the optical sheet 830 and the diffusion plate 820 and supports an end of the LCD panel 710. Similarly, the second mold 870 may be a frame that is integrally formed into one piece. However, the second mold 870 may include two pieces having a substantially U shape or four pieces corresponding to four sides of the flat-type fluorescent lamp 100, respectively.

The LCD apparatus 800 may further include a top chassis 880 so as to fix the display unit 700. The top chassis 880 is coupled to the receiving container 840 to fix the end of the LCD panel 710 to the receiving container 840. The data PCB 722 is bent by means of the data FPC film 726 such that the data PCB 722 is fixed to the side portion or the rear portion of the receiving container 840. The top chassis 880 includes a metal having a superior strength.

According to the flat-type fluorescent lamp and the LCD apparatus having the flat-type fluorescent lamp, the insulating member prevents exposure of the conductive clip to which the high voltage is applied, thereby preventing the electrical defect such as the arc discharge between the receiving container and the external conductors.

Also, the insulating member may prevent deformation of the conductive member, so that the conductive clip may have enhanced assembling efficiency. Thus, the external electrodes are more stably connected to each other via the conductive clip.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A flat-type fluorescent lamp comprising:
a lamp body emitting a light, the lamp body divided into a plurality of discharge spaces;
an external electrode formed on at least one face of an upper face and a lower face of the lamp body;
a conductive clip applying a discharge voltage to the lamp body, the conductive clip electrically connected to the external electrode; and
an insulating member covering the conductive clip and insulating the conductive clip.

2. The flat-type fluorescent lamp of claim 1, wherein the external electrode comprises:
a first external electrode formed on the upper face of the lamp body; and
a second external electrode formed on the lower face of the lamp body.

3. The flat-type fluorescent lamp of claim 2, wherein the conductive clip comprises:
a first contact portion making contact with the first external electrode;
a second contact portion making contact with the second external electrode; and
a body portion connecting the first contact portion to the second contact portion.

4. The flat-type fluorescent lamp of claim 3, wherein the insulating member covers the body portion.

5. The flat-type fluorescent lamp of claim 4, wherein the insulating member comprises a recess into which the body portion is inserted.

6. The flat-type fluorescent lamp of claim 5, wherein the insulating member has a unitary structure with a first section surrounding an inner surface of the body portion and a second section surrounding an outer surface of the body portion, the first section spaced from the second section by the recess.

7. The flat-type fluorescent lamp of claim 4, wherein the insulating member comprises:
a first insulating part disposed between the lamp body and the body portion; and
a second insulating part coupled to the first insulating part and covering the body portion.

8. The flat-type fluorescent lamp of claim 7, wherein one of the first insulating part and the second insulating part includes a fixing recess and another of the first insulating part and the second insulating part includes a fixing protrusion, the fixing protrusion combined with the fixing recess.

9. The flat-type fluorescent lamp of claim 7, wherein the first insulating part includes an outer surface receiving the body portion, the outer surface including an indentation having a substantially same width as a width of the body portion.

10. The flat-type fluorescent lamp of claim 4, wherein the body portion further comprises a fixing portion so as to connect a power line to the body portion.

11. The flat-type fluorescent lamp of claim 10, wherein the insulating member includes an opening receiving the fixing portion.

12. The flat-type fluorescent lamp of claim 4, wherein the first and second contact portions are soldered to the first and second external electrodes, respectively.

13. The flat-type fluorescent lamp of claim 12, wherein each of the first and second contact portions comprises at least one hole formed there through.

14. The flat-type fluorescent lamp of claim 2, wherein the conductive clip has a width that is equal to or less than a width of one of the first and second external electrodes.

15. The flat-type fluorescent lamp of claim 1, wherein the lamp body comprises:
a first substrate; and
a second substrate coupled to the first substrate, the discharge spaces formed between the first substrate and the second substrate.

16. The flat-type fluorescent lamp of claim 15, wherein the first substrate comprises:
a plurality of discharge space portions spaced apart from the second substrate, the discharge spaces formed within the discharge space portions;
a plurality of space-dividing portions disposed between the discharge space portions and making contact with the second substrate to divide the discharge space portions; and
a sealing portion disposed at an end of the first substrate and coupled to the second substrate.

17. The flat-type fluorescent lamp of claim 16, wherein the first substrate further comprises a connection path connecting adjacent discharge spaces to each other.

18. The flat-type fluorescent lamp of claim 16, wherein the external electrode is extended in a substantially perpendicular direction to a longitudinal direction of the discharge space portions such that the external electrode is intersected with the discharge spaces.

19. The flat-type fluorescent lamp of claim 1, wherein the conductive clip is insertable within the insulating member.

20. The flat-type fluorescent lamp of claim 1, wherein the insulating member is separable from the conductive clip.

21. The flat-type fluorescent lamp of claim 20, wherein the insulating member protects the conductive clip from deformation and prevents an arc discharge from occurring between the conductive clip and a conductive member exterior of the flat-type fluorescent lamp.

22. A liquid crystal display apparatus comprising:
a flat-type fluorescent lamp comprising:
a lamp body emitting a light, the lamp body divided into a plurality of discharge spaces;
an external electrode formed on at least one face of an upper face and a lower face of the lamp body;
a conductive clip applying a discharge voltage to the lamp body, the conductive clip electrically connected to the external electrode; and
an insulating member covering the conductive clip and insulating the conductive clip;
an inverter applying a discharge voltage to the conductive clip for the flat-type fluorescent lamp; and
a liquid crystal display panel displaying an image using a light applied from the flat-type fluorescent lamp.

23. The liquid crystal display apparatus of claim 22, wherein the insulating member comprises a recess into which the conductive clip is inserted.

24. The liquid crystal display apparatus of claim 22, wherein the insulating member comprises:
a first insulating part disposed between the lamp body and the conductive clip; and
a second insulating part coupled to the first insulating part and covering the conductive clip.

25. The liquid crystal display apparatus of claim 24, wherein the external electrode comprises:
a first external electrode formed on the upper face of the lamp body; and
a second external electrode formed on the lower face of the lamp body.

26. The liquid crystal display apparatus of claim 25, wherein the conductive clip comprises:
a first contact portion making contact with the first external electrode;
a second contact portion making contact with the second external electrode; and
a body portion connecting the first contact portion to the second contact portion, the body portion maintained in an insulated state due to the insulating member.

27. The liquid crystal display apparatus of claim 26, wherein the body portion further comprises a fixing portion connecting a power line from the inverter to the body portion.

28. The liquid crystal display apparatus of claim 27, wherein the insulating member includes an opening receiving the fixing portion.

29. The liquid crystal display apparatus of claim 26, wherein the first and second contact portions are soldered to the first and second external electrodes, respectively.

30. The liquid crystal display apparatus of claim 29, wherein each of the first and second contact portions comprise at least one hole formed there through.

31. The liquid crystal display apparatus of claim 22, wherein the conductive clip has a width that is equal to or less than a width of the external electrode.

32. The liquid crystal display apparatus of claim 22, wherein the lamp body comprises:
a first substrate; and
a second substrate coupled to the first substrate,
wherein the first substrate comprises:
a plurality of discharge space portions spaced apart from the second substrate, the discharge spaces formed within the discharge space portions;
a plurality of space-dividing portions disposed between the discharge space portions and making contact with the second substrate to divide the discharge space portions; and
a sealing portion disposed at an end of the first substrate and coupled to the second substrate.

33. The liquid crystal display apparatus of claim 22, further comprising:
a diffusion plate diffusing the light from the flat-type fluorescent lamp, the diffusion plate disposed on the flat-type fluorescent lamp; and
at least one optical sheet disposed on the diffusion plate.

34. The liquid crystal display apparatus of claim 22, wherein the insulating member is separable from the conductive clip and protects the conductive clip from deformation.

35. The liquid crystal display apparatus of claim 22, further comprising a receiving container receiving the flat-type fluorescent lamp, the receiving container formed of a conductive material, wherein the insulating member prevents an arc discharge from occurring between the conductive clip and the receiving container.
